(19) United States
(12) Patent Application Publication
(10) Pub. No.: US 2007/0028124 A1
(43) Pub. Date: Feb. 1, 2007

(54) Measuring power-on-time in data processing systems

(76) Inventors: Russell Alan Resnick, Raleigh, NC (US); Howard Jeffrey Locker, Cary, NC (US); Randall Scott Springfield, Chapel Hill, NC (US)

Correspondence Address: LENOVO (US) IP Law, Mail Stop ZHHA/B675/PO Box 12195, 3039 Cornwallis Road, RTP, NC, 27709-2195, US

(21) Appl. No.: 11/193,934

(22) Filed: Jul. 29, 2005

(51) Int. Cl. G06F 1/00

(52) U.S. Cl. 713/300

(57) ABSTRACT

A system for measuring power-on parameters for data processing systems is disclosed. During periodic System Management BIOS states that interrupt operation of the data processing system, code is executed that estimates the amount of time a data processing system has been powered on. Also, code is executed that tracks the number of times a data processing system has been powered on. Variables related to power-on-time and number of times powered on are incremented and stored in PROM, for example an Asset ID EEPROM, during SMBIOS states. Incrementing and storing these variables during SMBIOS states minimizes latencies.

### TECHNICAL FIELD

The present invention relates in general to data processing systems, and in particular, to monitoring parameters related to power-on-time.

### BACKGROUND INFORMATION

It can be valuable to know the amount of time a data processing system is powered on. In addition, it can be valuable to know the number of times a data processing system has been powered on. Features that provide such information can serve as an “odometer” for the data processing system. To implement these features, dedicated hardware can be used; however, dedicated hardware can be expensive. Software implementations may present too much overhead if they endeavor to track power-on-time with great accuracy. In some applications, it may only be necessary to estimate power-on-time to the nearest hour.

Therefore, there is a need for a low-overhead, inexpensive mechanism to estimate power-on-time for data processing systems. There is also a need for a mechanism to track the number of times a data processing system is powered on.

### SUMMARY OF THE INVENTION

The present invention addresses these needs by providing a method for monitoring parameters related to power-on-time of data processing systems. In one embodiment of the present invention, a first variable is incremented in response to a System Management BIOS (SMBIOS) management interrupt. The first variable is compared to a second variable to estimate whether the data processing system has been powered on for a predetermined time. In response to estimating the data processing system has been powered on for the predetermined time, a third variable in an Asset ID EEPROM is accessed. The third variable is for counting a total number of hours the data processing system operates. The third variable is incremented and written to the Asset ID EEPROM during the SMBIOS state.

Another embodiment of the present invention is a method including accessing a fourth variable in response to booting the data processing system. The fourth variable is incremented and written to the Asset ID EEPROM during a first SMBIOS state.

The foregoing has outlined rather broadly the features and technical advantages of the present invention so that the detailed description of the invention that follows may be better understood. Additional features and advantages of the invention will be described below.

### BRIEF DESCRIPTION OF THE DRAWINGS

For a more complete understanding of the present invention, refer to the following description taken in conjunction with the accompanying drawings, in which:

FIG. 1 illustrates a data processing system for implementing an embodiment of the present invention; and

FIG. 2 illustrates a flow diagram of method steps practiced in accordance with an embodiment of the present invention.

### DETAILED DESCRIPTION

In the following description, numerous specific details are set forth such as data processing elements, method steps, software coded instructions, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Many data processing systems contain a Basic Input/Output System (BIOS). The BIOS is typically placed in a ROM chip (read only memory chip) or Flash that is integrated with the data processing system in such a way to ensure that the BIOS will generally always be available and will not be damaged or affected by disk failures or power outages. BIOS may control many of the low-level configuration parameters that determine how a data processing system functions. For example, BIOS may control the keyboard, display screen, disk drives, serial communications, and a number of miscellaneous functions of a data processing system. For various hardware coupled to a data processing system, BIOS may also keep a list of devices with associated configuration information needed for functionality. BIOS also makes it possible for a computer to boot itself.

The BIOS of many data processing systems supports an interface called System Management BIOS (SMBIOS). The SMBIOS provides firmware that facilitates access to hardware component information and may store the information in a database located in an Asset ID EEPROM. The Asset ID EEPROM may be stored in non-volatile memory space and may contain information such as the serial numbers of key hardware components. The Asset ID EEPROM may also include a number of blank fields a developer may use to record other information. The Asset ID EEPROM may be read from and written to using a system bus interface or using wireless communication, such as over radio frequency.

The power-on-time (POT) for a data processing system can be measured without expensive, dedicated hardware and without software implementations that result in too much latency. POT can be measured by implementing software code that executes in conjunction with a data processing system's System Management Basic Input/Output System (SMBIOS). SMBIOS can be any state that a data processing system enters periodically to control and monitor certain aspects of the data processing system. For example, SMBIOS can interrupt a data processing system every 32 seconds to monitor temperatures and adjust fans for proper cooling. POT instructions can be coded to execute in conjunction with each SMBIOS state. In accordance with an embodiment of the present invention, each time the SMBIOS state is achieved, the code can increment a variable stored in RAM that can be used to determine when a data processing system has been on for a predetermined time, such as one hour. For example, if the variable stored in RAM exceeds a value of 113 in a system that enters SMBIOS every 32 seconds, the code can estimate that the data processing system has been on for at least one hour. This is because the mathematical product of 113 and 32 is 3616, which is greater than the 3600 seconds in an hour.

Keeping track of overall POT over multiple power-on cycles requires storage that retains values after power is turned off. Flash, PROM, (Programmable Read Only Memory) or EEPROM (Electronically Erasable PROM) can be used to store POT variables. However, accessing and incrementing variables in EEPROM, PROM, or Flash can result in unwanted latencies. Therefore, a POT tracking system optimally implements a low-latency manner of updating POT variables.

By way of example, the following discussion will assume POT variables are stored in PROM, though embodiments of the present invention may utilize EEPROM, EPROM, Flash or other such memory to store POT variables. Embodiments of the present invention achieve low-latency updating of POT variables by accessing the PROM, for purposes of tracking POT, only after estimations that the data processing system has been powered on for a predetermined time, such as an hour. However, to count the number of times a data processing system has been powered on, a POT variable stored in RAM is repeatedly accessed, incremented, and written back to RAM. Accordingly, by limiting the frequency with which variables stored in PROM are updated, embodiments of the present invention limit latency caused by tracking data related to measuring the time and number of instances a data processing system is powered on.

Refer now to the drawings wherein depicted elements are not necessarily shown to scale and wherein like or similar elements may be designated by the same reference numeral through the several views.

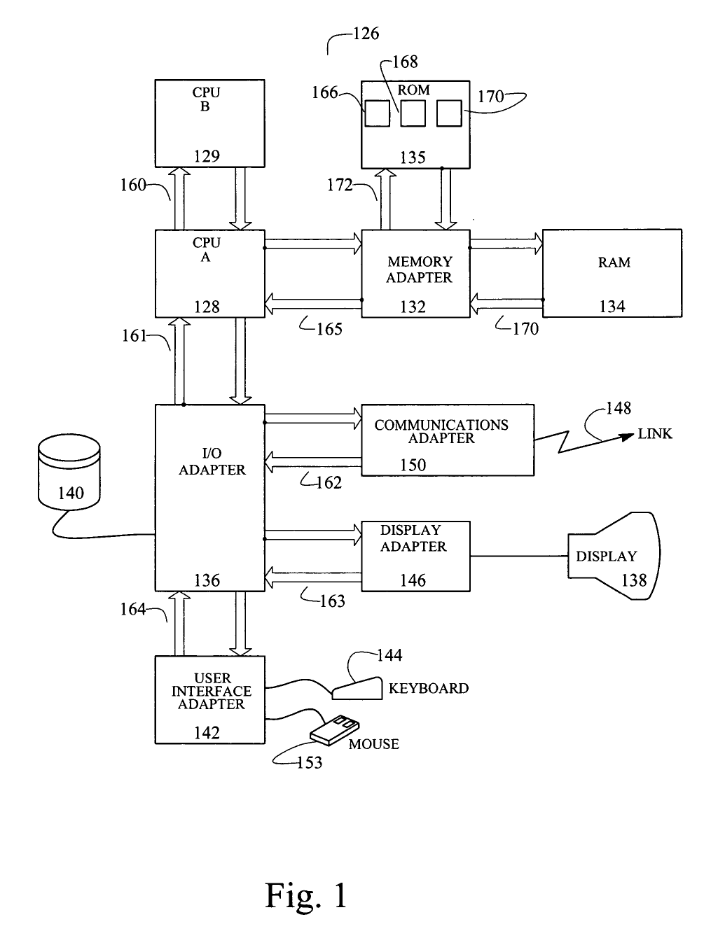

FIG. 1 is a block diagram of a representative data processing system 126 suitable for practicing the present invention. Data processing system 126 includes central processing units (CPUs) 128 and 129. More than two (or a single) CPUs are possible and would be within the scope of the present invention. CPU 128 and CPU 129 are coupled with bus 160 and CPU 128 is coupled to I/O (input/output) adapter 136 with bus 161 and to memory adapter 132 with bus 165. Memory adapter 132 is also coupled to read-only memory (ROM) 135 and random access memory (RAM) 134. System buses (e.g., 160-165) may operate in accordance with a standard bus protocol, such as the ISA protocol, compatible with CPUs 128 and 129. As shown in data processing system 126, ROM 135 includes storage of BIOS 166 (basic input output system), SMBIOS 168 (System Management BIOS), and Asset ID EEPROM 170. The ROM 135 may be an electronically erasable programmable ROM (EEPROM) or other such types of read-only memory. The ROM 135 may consist of a single chip, multiple chips, or any machine readable memory that stores information when power is turned off to data processing system 126. The RAM 134 may include, for example, DRAM (dynamic random access memory) system memory and SRAM (static random access memory) external cache.

While CPU 128 is processing a software application's instructions, SMBIOS 166 may generate an SMBIOS interrupt that results in data processing system 126 entering an SMBIOS state. Alternatively, a periodic timer or heartbeat timer can be implemented in software code and executed using CPU 128 to interrupt “normal” processing and result in an SMBIOS state. During such SMBIOS states, CPU 128 interrupts “normal” processing and may perform system functions such as adjusting fans, etc. Such SMBIOS states may occur at repeated intervals, such as every 32 seconds. In accordance with an embodiment of the present invention, during these SMBIOS states, a variable stored in RAM 134 is accessed over interface 170, incremented, and compared to a predetermined variable so that an estimation can be made whether the data processing system 126 has been on for 1 hour. If the variable equals or exceeds the predetermined value indicating the data processing system 126 has been on for 1 hour, CPU 128 may access, using interface 172, an hour-counting variable in the Asset ID EEPROM 170. The CPU 128 increments the hour-counting variable and writes the incremented variable, using interface 172, back to the Asset ID EEPROM 170. Accordingly, the system estimates the number of hours data processing system 126 is powered on by executing counting software code during SMBIOS states. By only accessing Asset ID EEPROM 170 when the variable reaches a predetermined value, latency caused by frequently accessing the Asset ID EEPROM is reduced.

Still referring to FIG. 1, I/O adapter 136 allows for an interconnection between various devices. I/O adapter 136 is coupled to communications adapter 150 with bus 162 which may send and receive data on communications link 148. I/O adapter 136 also couples to display adapter 146, which is in turn coupled to a display 138 for displaying video and text information. I/O adapter 136 also couples to external peripherals, such as mass storage devices 140 (e.g., a hard drive, floppy drive, printer, or CD/ROM drive). A peripheral device 140 is coupled, for example, to a PCI (peripheral control interface) bus, and therefore I/O adapter 136 may be a PCI bus bridge. User interface adapter 142 couples to I/O adapter 136 with bus 164 and to various user input devices, such as a keyboard 144 or mouse 153. Display 138 may be, for example, a cathode ray tube (CRT), liquid crystal display (LCD) or similar conventional display unit. Display adapter 146 may include, among other things, a conventional display controller and frame buffer memory. Communications adapter 150 may include, for example, a modem for connection to a telecom network and/or hardware and software for connecting to a computer network such as a local area network (LAN) or a wide area network (WAN).

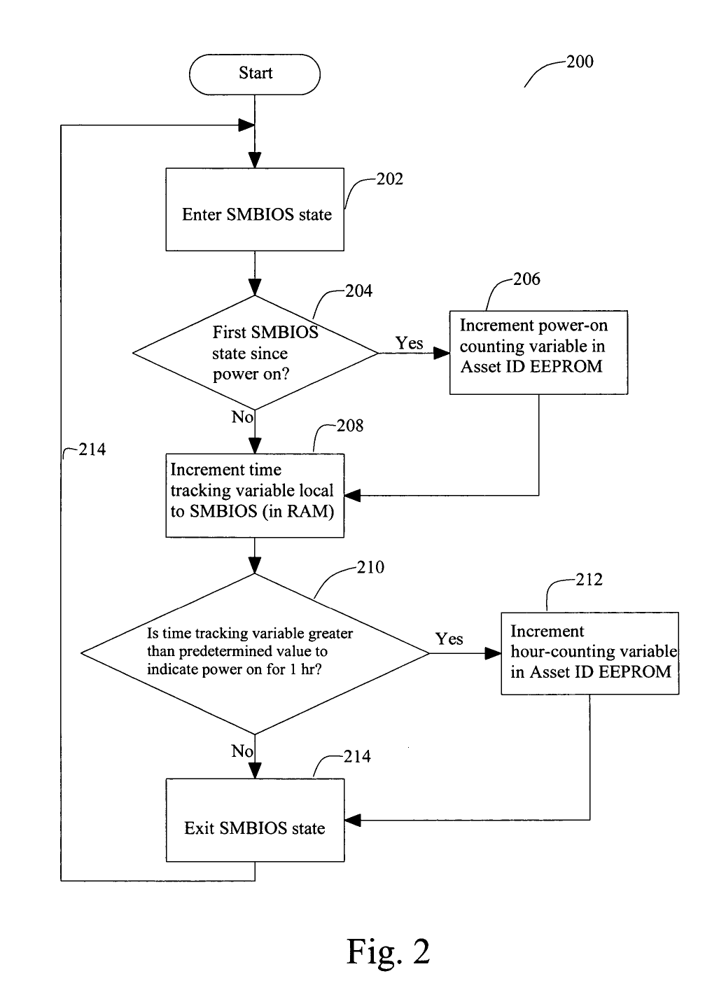

Referring now to FIG. 2, methodology 200 illustrates method steps for an embodiment of the present invention. In step 202, an SMBIOS state is entered in which execution of normal code by CPU 128 (FIG. 1) is stopped. During the SMBIOS state, system functions used to control data processing system 126 are performed. For example, the temperature surrounding data processing system 126 could be measured and a fan (not shown) could be turned on in response to a high temperature. In accordance with embodiments of the present invention, this SMBIOS state is utilized to track POT and instances of power on for data processing system 126. The SMBIOS state can be entered into by SMBIOS code 168 (FIG. 1) creating an interrupt or by a heartbeat or periodic timer coded (not shown) into instructions executed by CPU 128 (FIG. 1). In step 204, a determination is made whether it is the first SMBIOS state since power on. This determination can be made by accessing a toggled variable stored in RAM 134 (FIG. 1). If it is the first SMBIOS state since power-on, in step 206 a power-on counting variable stored in Asset ID EEPROM 170 (FIG. 1) is accessed, incremented, and written back to Asset ID EEPROM 170 (FIG. 1). If it is not the first SMBIOS state since power on, in step 208 a time tracking variable stored in RAM 134 (FIG. 1) is incremented. A determination is made in step 210 whether the time-tracking variable is greater than a predetermined value. Depending on the frequency of SMBIOS state occurrences, the predetermined value can be scaled to provide an estimation of whether an hour has passed. If the time-tracking variable indicates an hour has passed, in step 212 an hour-counting variable stored in Asset ID EEPROM 170 (FIG. 1) is accessed, incremented, and written back to Asset ID EEPROM 170 (FIG. 1). If the time-tracking variable is determined in step 210 to indicate data processing system 126 has not been powered on for an hour, any remaining SMBIOS state functions are executed and the SMBIOS state is exited for “normal” (non-SMBIOS) processing by CPU 128. CPU 128 (FIG. 1) continues executing “normal” code until the next SMBIOS state begins in step 202.

Referring again to FIG. 1, in accordance with embodiments of the present invention, variables related to power-on-time may be stored in a data processing system's Asset ID EEPROM 170. The Asset ID EEPROM 170 can be any Flash, EEPROM, or PROM used to store information or code regarding the data processing system and its associated hardware. For example, Asset ID EEPROM 170 can be used to store in-service date for a motherboard and serial numbers for input/output devices used by the data processing system 126. After powering on the data processing system and upon the first instance of entering an SMBIOS state, a variable which counts instances of power on may be accessed over interface 172 from Asset ID EEPROM 170, incremented, and written back over interface 172 to Asset ID EEPROM 170. Similarly, after an hour of operation by the data processing system and during an SMBIOS state, a variable that tracks POT can be accessed from the Asset ID EEPROM, incremented, and written back to the Asset ID EEPROM. Accordingly, by limiting the number of times the Asset ID EEPROM is accessed, POT data can be stored without resulting in excessive latency.

Although the present invention and its advantages have been described in detail, it should be understood that various changes, substitutions and alterations can be made herein without departing from the spirit and scope of the invention as defined by the appended claims.

What is claimed is:

1. A method for monitoring operation of a data processing system, the method comprising the steps of:
incrementing a first variable in response to an SMBIOS management interrupt;
comparing the first variable to a second variable to estimate whether the data processing system has been powered on for a predetermined period of time;
in response to estimating the data processing system has been powered on for the predetermined period of time, accessing a third variable in an Asset ID EEPROM, wherein the third variable is for counting a total number of hours the data processing system operates;
incrementing the third variable; and
writing the incremented third variable to the Asset ID EEPROM.

2. The method of claim 1, further comprising the steps of
accessing a fourth variable in response to booting the data processing system;
incrementing the fourth variable; and
writing the incremented fourth variable to the Asset ID EEPROM.

3. The method of claim 1, wherein the SMBIOS management interrupt is one of a series of interrupts that occurs every 32 seconds.

4. The method of claim 1, wherein the predetermined period of time is one hour.

5. The method of claim 1, wherein the SMBIOS management interrupt occurs in response to a period timer.

6. The method of claim 1, the method further comprising the step of:
sending the fourth variable over a communications link to a second data processing system.

7. The method of claim 1, the method further comprising the step of:
displaying the first variable on a display screen; and
displaying the second variable on the display screen.

8. The method of claim 1, the method further comprising the step of:
sending the third variable over a communications link to a second data processing system.

9. A data processing system comprising:
(a) an Asset ID EEPROM for storing a first variable, wherein the first variable is for counting the number of hours the data processing system is powered on;
(b) an interrupter for generating an SMBIOS management interrupt at a predetermined interval, wherein the predetermined interval is less than 1 minute;
(c) first circuitry for incrementing a first counter, assessing the value of the first counter compared to a predetermined value, and thereby estimating whether the data processing system has been powered on for a predetermined time;
(d) second circuitry for, in response to the second circuitry estimating that the data processing system has been powered on for the predetermined time,
(i) accessing the first variable;
(ii) incrementing the first variable to result in an incremented first variable; and
(iii) writing the incremented first variable to the Asset ID EEPROM.

10. The data processing system of claim 9, wherein the Asset ID EEPROM is for storing a second variable, wherein the second variable is for determining the number of times the data processing system is powered on, the data processing system further comprising:
(e) fourth circuitry for accessing the second variable, incrementing the second variable to result in an incremented second variable, and writing the incremented second variable to the Asset ID EEPROM, wherein accessing the second variable is in response to powering on the data processing system.

11. The data processing system of claim 9, wherein the predetermined time is one hour.

12. The data processing system of claim 9, wherein the data processing system further comprises fifth circuitry for sending the incremented first variable to a second data processing system.

13. The data processing system of claim 12, wherein the fifth circuitry is for sending the incremented second variable to the second data processing system.

14. A machine-readable medium having stored thereon machine-readable code to permit a machine to effect a method of monitoring on-time for the machine, the method comprising:
incrementing a first variable in response to an SMBIOS management interrupt;
comparing the first variable to a second variable to estimate whether the machine has been powered on a predetermined time;
in response to estimating the machine has been powered on for the predetermined time, accessing a third variable in an Asset ID EEPROM, wherein the third variable is for counting a total number of hours the data processing system operates;
incrementing the third variable; and
writing the incremented third variable to the Asset ID EEPROM.

15. The machine-readable medium of claim 14, wherein the method further comprises the steps of:
accessing a fourth variable in response to booting the machine;
incrementing the fourth variable; and
writing the incremented fourth variable to the Asset ID EEPROM.

16. The machine-readable medium of claim 14, wherein the SMBIOS management interrupt is one of a series of interrupts that occurs every 32 seconds.

17. The machine-readable medium of claim 14, wherein the predetermined period of time is one hour.

18. The machine-readable medium of claim 14, wherein the SMBIOS management interrupt occurs in response to a period timer.

19. The machine-readable medium of claim 14, wherein the method further comprises the steps of:
sending the fourth variable over a communications link to a second data processing system.

20. The machine-readable medium of claim 14, wherein the method further comprises the steps of:
sending the third variable over a communications link to a second data processing system.
